(19) United States
(12) Patent Application Publication
(10) Pub. No.: US 2006/0210440 A1
(43) Pub. Date: Sep. 21, 2006

(54) Opto-acoustic sensor system and associated method

(75) Inventors: Radislav Alexandrovich Potyrailo, Niskayuna, NY (US); Timothy Mark Sivavec, Clifton Park, NY (US); Joseph James Salvo, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/391,743

(22) Filed: Mar. 29, 2006

Related U.S. Application Data
(63) Continuation-in-part of application No. 09/920,281, filed on Aug. 2, 2001, now abandoned.
Application No. 09/920,281 is a continuation-in-part of application No. 09/441,851, filed on Nov. 17, 1999, now Pat. No. 6,461,872.
Application No. 09/920,281 is a continuation-in-part of application No. 09/917,349, filed on Jul. 30, 2001, now Pat. No. 6,676,903.

(51) Int. Cl. G01N 27/00

(52) U.S. Cl. 422/82.01; 422/82.11

(57) ABSTRACT

A system that includes a device is provided in which the device includes a piezoelectric substrate; a sensor layer disposed on the substrate and operable to interact with, or react with, a target species; a first and a second electrode that are spaced from each other and in communication with the substrate; a first detector operable to detect the interaction or the reaction of the sensor layer with the target species based on a change in an optical characteristic of electromagnetic radiation propagated through the substrate; and a second detector operable to acoustically detect the interaction or the reaction of the sensor layer with the target species. Associated methods are provided.

### CROSS REFERENCE TO RELATED APPLICATION

This application is continuation-in-part of U.S. patent application Ser. No. 09/920,281, filed Aug. 2, 2001, which is a continuation-in-part of U.S. Pat. No. 6,461,872 and of U.S. Pat. No. 6,676,903.

### BACKGROUND

1. Technical Field

The invention includes embodiments that relate to a device, apparatus, or system for detecting, locating, or quantifying target species. The invention includes embodiments that relate to a method for detecting, locating, or quantifying target species.

2. Discussion of Related Art

“Opto-acoustic wave detection’ is a method of detection in which the identity and the amount or concentration of a target species may be ascertained by a combination of at least one optical signal and one acoustic wave signal.

Some compounds may react with selected sensor layer components to yield products that absorb electromagnetic (“EM”) radiation in a wavelength range of from ultraviolet (“UV”) to infrared (“IR”). The optical effects of selective chemical interaction may be incorporated in optical fibers for the determination of the location or the spatial distribution of selected chemical compounds by measuring the backpropagated electromagnetic radiation. Such method is known as optical time-domain reflectometry or OTDR. A fiber-optic waveguide having an aluminosilica xerogel clad may detect the spatial distribution of quinizarin (1,4-dihydroxyanthraquinone). Quinizarin adjacent to the optical fiber sensor may complex with aluminum in the clad to yield a product that strongly absorbs electromagnetic radiation at wavelength of about 560 nm. A measurement of the light intensity at wavelength of 560 nanometers and the arrival time at the detector of the return light of a pulse of light launched into the fiber-optic waveguide may indicate the concentration and the location of quinizarin.

It may be desirable to have an article, apparatus, and/or method having features and aspects not currently available. Such features and aspects may include one or more of detecting, identifying, locating, or quantifying a target species.

### BRIEF DESCRIPTION

Embodiments of the invention may relate to a system that includes a device, which includes a piezoelectric substrate; a sensor layer disposed on the substrate and operable to interact with, or react with, a target species; a first and a second electrode that are spaced from each other and in communication with the substrate; a first detector operable to detect the interaction or the reaction of the sensor layer with the target species based on a change in an optical characteristic of electromagnetic radiation propagated through the substrate; and a second detector operable to acoustically detect the interaction or the reaction of the sensor layer with the target species.

In one embodiment, a biodetection system may include a piezoelectric substrate; a sensor layer disposed on the substrate and operable to interact with, or react with, a target species; a first and a second electrode, that are spaced from each other and in communication with the substrate; and a first detector operable to detect the interaction or the reaction of the sensor layer with the target species based on a change in an optical characteristic of electromagnetic radiation propagated through the substrate, and a second detector operable to acoustically detect the interaction or the reaction of the sensor layer with the target species; wherein the sensor layer may include one or more sensor layer components. The sensor layer components may include one or more selected from the group consisting of an aptamer, antibody, protein, peptide, small molecule, nucleic acid sequence, flour-quencher pair dye, pH activatable dye, ion-sensor dye, chelator conjugated antibody dye with cleavable or non-cleavable linker, lanthanide chelate dye, cleavable linker disulfide dye, alkoxysilane dye, photochemically responsive dye, alkylsulfone dye, chromophore attachment moiety, chromophore-targeting moiety, chromophore probe, albumin, transferrin, fatty acid binding protein, globulin, a red blood cell component, lyphocyte, stem cell, lipoprotein, polylysine, polysaccharide, and thiol or disulfide group.

In one aspect, the system includes a chromophore probe. The chromophore probe may include one or more of Cy5.5, Cy5, Cy7, IRD41, IRD700, NIR-1, 1C5-Osu, Alexflour 660, Alexflour 680, LaJolla Blue, FAR-Blue, FAR-Green One, FAR-Green Two, ADS 790-NS, ADS 821-NS, indocyanine green or analog thereof, indotricarbocyanine, or chelated lanthanide composition.

In one embodiment, a method is provided that may include disposing the system within a multi-step manufacturing process so that intermediate samples, precursors, or both are contacted to the sensor layer prior to proceeding to a subsequent manufacturing process step. In one aspect, the manufacturing process may produce one or more of cosmetics, food products, or pharmaceuticals, and the target species comprises one or more of water, amine, diamine, or short chain alcohol.

In one embodiment, a method is provided that may include contacting the system to a bodily fluid suspected of containing the target species, and selectively detecting the target species in the bodily fluid.

### BRIEF DESCRIPTION OF THE DRAWINGS

FIG. 1 is a schematic diagram of an apparatus comprising an embodiment of the invention.

FIG. 2 is a schematic diagram of another apparatus comprising an embodiment of the invention.

FIG. 3 is a schematic diagram of another apparatus comprising an embodiment of the invention.

### DETAILED DESCRIPTION

The invention includes embodiments that relate to a device, apparatus, or system for detecting, locating, or quantifying target species. The invention includes embodiments that relate to a method for detecting, locating, or quantifying target species.

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. “Free” may be used in combination with a term, and may include an insubstantial number or trace amounts while still being considered free of the modified term, and “free” may include further the complete absence of the modified term. Transparent refers to the free passage of electromagnetic radiation.

In one embodiment, a device may include a substrate, a sensor layer, at least two electrodes, a first detector, and a second detector. The sensor layer may be disposed on the substrate and may interact with, or react with, a target species. The first detector may detect the interaction or the reaction of the sensor layer with the target species based on a change in an optical characteristic of electromagnetic radiation propagated through the substrate from the sensor layer to the first detector. The electrodes may respond to an oscillating electrical potential by resonating the substrate to form an acoustic response. The second detector may acoustically detect the interaction or the reaction of the sensor layer with the target species as the reaction or the interaction affects one or more acoustically detectable properties of the sensor layer.

The substrate may include, for example, an optical waveguide and an acoustic wave element. These may be the same. Suitable optical waveguides may include one or more optically transmissive fibers, plates, or elongate flat ribbons. Reaction or interaction of the target species with the sensor layer may create an optically detectable signal, as disclosed hereinbelow. Electromagnetic radiation may propagate at least from the sensor layer to the first (optical) detector. In one embodiment, the electromagnetic radiation propagates from an electromagnetic radiation source, through the substrate, through an electrode, and to the sensor layer, and then further propagates (having a detectable optical change) through the electrode, through the substrate, and to the first, optical detector. In one embodiment, the electromagnetic radiation propagates from the sensor layer where generated, and to the first, optical detector.

The waveguide may have an optional cladding layer. Suitable materials for use as the optical waveguide may include inorganic materials and optically transmissive polymeric materials. Suitable inorganic materials may include silicon dioxide or silicone. Other suitable inorganic materials may include one or more of fluorozirconate, fluoroaluminate, and chalcogenide glasses. In one embodiment, the substrate may include one or more of quartz, lithium niobate, lithium tantalate, langasite, or gallium orthophosphate. The glasses may have a refractive index of about 1.5. The substrate may be halogenated and/or doped, for example, with a metal. Suitable dopants may include germanium or erbium. Provided that material modifications may be made so it is possible to form the piezoelectric effect, suitable polymeric materials may include, for example, one or both of polyperfluorobutenyl vinyl ether or poly (methyl 2-methylpropanoate).

In one embodiment, the optical fiber may be a cylindrical dielectric waveguide that transmits light along its axis by internal reflection. The fiber may include a core surrounded by a cladding layer. For the fiber to guide the optical signal the refractive index of the core must be greater than that of the cladding so that light can be confined to the guiding layer by internal reflection. The boundary between the core and cladding may either be abrupt, in step-index fiber, or gradual, in graded-index fiber.

The substrate may have an average thickness of less than about 100 micrometers. In one embodiment, the substrate may have an average thickness in a range of from about 20 nanometers to about 50 nanometers, from about 50 nanometers to about 100 nanometers, from about 100 nanometers to about 150 nanometers, from about 150 nanometers to about 200 nanometers, from about 200 nanometers to about 300 nanometers, from about 300 nanometers to about 400 nanometers, from about 400 nanometers to about 500 nanometers, from about 500 nanometers to about 1000 nanometers, from about 1 micrometer to about 10 micrometers, from about 10 micrometer to about 100 micrometers, from about 100 micrometer to about 1 millimeter, or greater than about 1 millimeter.

The acoustic wave element may have piezoelectric properties. When mass is deposited onto the substrate, a change in acoustic signal of the resonator may occur. The change in acoustic signal may be a change in frequency, and may relate to one or more of mass, viscoelastic response, or dielectric property. The frequency change may be detected as disclosed hereinbelow.

Suitable acoustic wave materials may include one or more of quartz, gallium arsenite, lithium niobate, zinc oxide, alkali metal halide, or alkali earth halide. Suitable halides may include fluorides. In one embodiment, the substrate may be a thin piece of quartz crystal that may be cut at a specified angle with respect to the z-axis of the crystal. For example, the so-called AT-cut (35 degree 15 minute rotation with respect to z-axis) and BT-cut (−49 degrees with respect to z-axis) quartz crystals may be relatively unresponsive to temperature change and, therefore, may be suitable for sensor manufacture. The EM beam may be provided as a continuous beam or in pulses.

The electrodes may be pattern-deposited on surfaces of the substrate. When the device is a QCM (quartz crystal microbalance), the electrodes may be deposited on opposing surfaces of the substrate (acoustic wave crystal element). The sensor layer may be deposited on one of the electrodes. In order for the optical property of the interaction product in the sensor layer to affect the optical property of the input electromagnetic radiation, the electrode under the sensor layer may be transparent or semitransparent at least to the wavelength of light used. A suitable material for such an electrode may include a metal and/or a metal oxide. Suitable electrode metal material may include one or more of gold, silver, platinum, copper, zinc, aluminum, iron, or tungsten. Suitable metal oxides may include one or more of tin oxide, zinc oxide, or indium tin oxide. Other suitable electrodes may include carbon. In one embodiment, a carbon electrode may include single wall carbon nanotubes. Unless indicated otherwise, transparent includes semitransparent to the extent that a detectable amount of electromagnetic radiation is transmitted therethrough. Semitransparent may include materials with a transmission of at least 0.1 percent. In one embodiment, a semitransparent electrode may have a transmission in a range of from about 0.1 percent to about 1 percent, from about 1 percent to about 10 percent, from about 10 percent to about 20 percent, from about 20 percent to about 30 percent, from about 30 percent to about 40 percent, from about 40 percent to about 50 percent, from about 50 percent to about 75 percent, from about 75 percent to about 90 percent, from about 90 percent to about 99 percent, or greater than about 99 percent.

The electrode may have an average thickness of less than about 100 micrometers. In one embodiment, the electrode may have an average thickness in a range of from about 20 nanometers to about 50 nanometers, from about 50 nanometers to about 100 nanometers, from about 100 nanometers to about 150 nanometers, from about 150 nanometers to about 200 nanometers, from about 200 nanometers to about 300 nanometers, from about 300 nanometers to about 400 nanometers, from about 400 nanometers to about 500 nanometers, from about 500 nanometers to about 1000 nanometers, or greater than about 1 micrometer.

The light or electromagnetic source may provide the electromagnetic radiation as a continuous wave or as a pulse. For pulse applications, a nitrogen laser, a Nd:YAG laser, a Ti:Sapphire laser, or a dye lasers may be used. The source for the electromagnetic radiation may be a lamp (such as xenon arc lamp, mercury arc lamp, deuterium lamp, tungsten lamp), a light-emitting diode (“LED”), or a laser diode. The electromagnetic radiation may react or may interact with the sensor layer, and a portion of the electromagnetic radiation intensity may be absorbed. In one embodiment, the product of the chemical interaction or reaction of the target species with the sensor layer component in the sensor layer may modify another, different electromagnetic radiation property (e.g., frequency or wavelength). Alternatively, the reaction product or interaction product may emit light that may be detectable. The remainder of the input electromagnetic radiation may exit the opto-substrate, and the intensity, or another light property, may be measured by the corresponding detector. The absorption of light at the characteristic wavelength of the electromagnetic radiation or another measurable light property (such as luminescence or scattering) may be due to the presence of the reaction product, or the interaction product, of the target species with the sensor layer and may relate to the identity of the target species.

The interaction or the reaction may produce light as a result of the reaction process. Examples of these reactions may include chemoluminescence reactions and bioluminescence reactions. For these types of reactions, only an optical detector is needed without the need for the electromagnetic source.

Suitable detectors for use detecting optically detectable changes in the sensor layer, as a response to reaction or interaction with the target species, may include, for example, a photodiode or charge coupled device. Examples of manufacturers and distributors of suitable photodiodes may include, for example, Hamamatsu Photonics K. K. (Hamamatsu City, Japan), and International Radiation Detectors, Inc. (Torrence, Calif.). Examples of electromagnetic sources may include ultraviolet LED, which are commercially available from, for example, Nichia America Corporation (Mountville, Pa.).

Suitable piezoelectrically-based resonators may include one or more of bulk acoustic wave (BAW), surface acoustic wave (SAW), or Love mode devices. The target species reaction or interaction influences the sensed frequency to provide a detectable change. In one embodiment, the detector may be a thickness-shear-mode (“TSM”) device, such as a QCM; a SAW sensor; a flexural-acoustic-plate-wave (“FPW”) sensor; or a shear-horizontal-acoustic-plate-mode (“SH-APM”) sensor. Suitable non-piezoelectrically-based resonators may include, for example, MEMS cantilevers and other structures that can operate in the static and dynamic modes.

The sensor layer may include one or more sensor layer components (e.g., reagents, binders, capture agents) that react with the target species. The sensor layer may include one or more sensor layer components that interact with the target species. The sensor layer may include one or more sensor layer components, and at least one sensor layer component reacts with, and at least another sensor layer component interacts with, a target species; the target species may include differing moieties that react with, or interact with, correspondingly differing sensor layer components in the sensor layer. The sensor layer may include the sensor layer component capable of undergoing a selective chemical interaction with a target species to yield at least one optically detectable interaction product or reaction product.

A sensor layer component for a particular target species may react or may interact to yield a product that strongly absorbs electromagnetic radiation in a particular frequency or wavelength. Suitable electromagnetic may include ultraviolet, visible, or infrared electromagnetic radiation. Alternatively, the interaction or the reaction product may emit detectable electromagnetic radiation. Such detectable emission may be in the visible spectrum. The sensor layer component may be chosen such that the product of the reaction or interaction may provide an optical signature that is indicative of, or unique to, the target species. An optical signature may be represented by a measurable optical signal. More than one optical signal, such as absorbance at two differing wavelengths or other light properties, may be measured to uniquely identify the target species.

Examples of optical responses may include one or more of elastic light scatter, colorimetric changes, fluorescence, photoluminescence, Raman scatter, diffraction, interference, surface enhanced Raman, metal enhanced fluorescence, or surface plasmon resonance. Other optical responses may include one or more of chemoluminescence, bioluminescence, triboluminescence. The sensor layer components may be selected so that the optical response may be steady state or may be dynamic.

A suitable sensor layer may be permeable to the target species, and may resist damage by environmental conditions. Other suitable sensor layers may have an affinity for the target species.

For use in the sensor layer, suitable polymeric materials may include one or more polyolefin and halogenated polyolefin derivatives. Suitable polyolefins may include one or both of polyethylene or polypropylene. Suitable polyethylene may include one or more of linear low-density polyethylene or high-density polyethylene. Suitable halogenated polyolefin derivatives may include one or more of polytetrafluoroethylene, poly(vinyl chloride), or poly(vinylidene fluoride). Other suitable polymeric materials may include one or more of polyurethane, polycarbonate, polystyrene, polyamide, poly ether amide, polyether imide, poly bismaleimide, polyphenylene oxide, poly(vinyl alcohol), polyarylsuphones, polyacrylonitrile, polyether, polyetherurethane, poly(ether thioether), poly(methyl methacrylate), polyvinylpyrrolidone, polysiloxane, and derivatives thereof, copolymers of two or more thereof, and blends of two or more thereof. Other suitable polymeric materials may include nylon and/or cellulose.

A suitable sensor layer may be mesoporous or microporous. Mesoporous may have an average pore size in a range of less than about 1000 nanometers. Microporous may have an average pore size in a range of greater than about 1000 nanometers. In one embodiment, the average pore size is a bimodal distribution having both mesoporous and microporous pores. The pore size may be selected based on determined factors. Such factors may include the desire to obtain a reasonably rapid diffusion or permeation rate of the target species into and throughout the sensor layer. Other factors may include the use of size exclusion affects to preclude reaction or interaction of the target species with the sensor layer.

The average pore size may be selected to have a narrow size distribution. For mesoporous sensor layer layers, suitable average pore sizes may be in a range of from about 1 nanometer to about 10 nanometers, from about 10 nanometers to about 25 nanometers, from about 25 nanometers to about 75 nanometers, from about 75 nanometers to about 100 nanometers, from about 100 nanometers to about 250 nanometers, from about 250 nanometers to about 500 nanometers, from about 500 nanometers to about 750 nanometers, or from about 750 nanometers to about 1000 nanometers. For microporous sensor layer layers, suitable average pore sizes may be in a range of from about 1 micrometer to about 10 micrometers, from about 10 micrometers to about 25 micrometers, from about 25 micrometers to about 75 micrometers, from about 75 micrometers to about 100 micrometers, from about 100 micrometers to about 250 micrometers, from about 250 micrometers to about 500 micrometers, from about 500 micrometers to about 750 micrometers, from about 750 micrometers to about 1000 micrometers, or greater than about 1000 micrometers.

The polymeric material may be deposited on the acoustic wave-sensing element by spraying, dipping, painting, electrospinning, or by depositing a monomer from the vapor phase and then polymerizing the monomer. The formation of the sensor layer may be carried out by a pattern deposition using a mask similar to microelectronic manufacture. Alternatively, the porous polymeric material may be impregnated in another porous support such as a thin film of porous glass; quartz; or piezoelectric material, non-limiting examples of which are gallium arsenite, lithium niobate, or zinc oxide; which may be deposited on the substrate.

In one embodiment, an exclusion layer may be disposed over some or all of an exposed surface of the sensor layer. The exclusion layer may selectively exclude, or prevent contact with or protect, the sensor layer based on determined criteria. The exclusion may be based on one or more characteristic of the target species (allowing it to pass) or of the non-target species (preventing contact with the sensor layer). Selective exclusion may be based on one or more of size, polarity, affinity, hydrophobicity, conformation or configuration, phase, and the like. A zeolyte, microporous, and/or mesoporous layer may exclude based on pore size alone. A lipid bi-layer may exclude based on polarity, or protein content, for example. A Lotus-effect structured surface may prevent liquid from contact, but may allow for gas-phase contact. An expanded microporous membrane, e.g., e-PTFE, may be surface treated and used as the exclusion layer.

The sensor layer with the selective sensor layer component for the target species may impart to the acoustic wave-sensing element the measurable optical characteristic and, thus, the ability to accurately identify the target species. Reversible color changes may occur when solvatochromic (SV) dyes incorporated into the sensor layer may experience a polarity change, particularly in instance where there is an interaction. The sensor layer may include an immobilized SV dye in a polymer film coated onto the planar waveguide, on the end of a clad optical waveguide (e.g., fiber), or on the sides of an unclad optical waveguide.

At least one sensor layer component for selectively interacting with or reacting with the target species may be incorporated in the sensor layer. The sensor layer component may be chemically attached to the sensor layer material such that a functional group responsible for the selective interaction with the target species may be free to undergo this interaction or reaction. Such a functional group may be a moiety on the sensor layer component or a part of the sensor layer component molecule that offers a determined steric configuration for accepting a target species having a complementarily shape and/or property.

An example of the latter interaction or reaction may be that between an enzyme and a substrate. A sensor layer component may even be a cell or part of a cell so that its membrane may be used to recognize biotarget species. A sensor layer component also can be a single stranded nucleic acid, known as an aptamer, folded into a specific conformation and sensitive to a variety of target species. Other sensor layer components may include antibodies, proteins, peptides, small molecules and the like. In one embodiment, the sensor layer component may include a nucleic acid sequence. An associated dye may include a flour-quencher pair, a pH activatable dye, an ion-sensor dye (preferably in situations where there is conjugation with an antibody), and chelator conjugated antibodies, with cleavable or non-cleavable linkers, that can form fluorescent chelates (e.g., lanthanide chelates). Other suitable sensor layer components may include one or more of cleavable linker disulfides (cleaved by reducing agents), alkoxysilane (cleaved by halides), photochemical agents (cleaved by light), and alkylsulfone (cleaved by basic materials).

In one embodiment, the sensor layer components may include a chromophore attachment moiety, a chromophore-targeting moiety, a chromophore probe, and the like. Suitable chromophore attachment moieties may include albumin, transferrin, fatty acid binding proteins, globulins, red blood cell components, lyphocytes, stem cells, antibodies, and lipoproteins; as well as polylysine and polysaccharides. Suitable chromophore-targeting moieties may include a thiol or disulfide group. Suitable chromophore probes may include a Cy5.5, Cy5 and Cy7; IRD41 and IRD700; NIR-1 and 1C5-Osu; Alexflour 660, Alexflour 680, LaJolla Blue; FAR-Blue, FAR-Green One, and FAR-Green Two; ADS 790-NS and ADS 821-NS. Other probes may include indocyanine green and analogs, indotricarbocyanine, and chelated lanthanide compounds.

For securing the sensor layer component to a sensor layer or in the sensor layer, the sensor layer component may be retained in pores of the sensor layer material. The retention may be by, for example, one or more of surface tension, molecular weight, affinity, chemical fixation, or configuration. The sensor layer component may be mixed with a suitable solvent or matrix having a low vapor pressure before impregnating into the pores of the sensor layer to inhibit the escape of the sensor layer component and to increase the shelf life of the sensing element. Depending on the nature of the target species suspected to be present, the solvent or matrix may be chosen to promote or enhance the solubilization of the target species therein. For example, a hydrophobic solvent or matrix may be used for hydrophobic target species, and hydrophilic solvent or matrix for hydrophilic target species.

The target species, that is, the material desired-to-be-detected, may associate with a component in the sensor layer. The association may be in equilibrium (an electronic interaction) or may be a chemical bonding (a reaction). The sensor layer may be selected with reference to which target species, or multiple target species, that is desired to be detected. In various embodiments the target species may include one or more metal ion, protein, living cells, virus, tissue, gaseous fire products, gaseous exhaust products, mine environmental gas (e.g., methane), and the like. In one embodiment, the target species may include a chemical warfare agent and/or a biological warfare agent. Suitable chemical warfare agents may include one or more incapacitating agents, lacrymators, vesicants or blister agents, nerve agents, pulmonary agents, blood agents, and malodorants.

Suitable incapacitating agents may include nervous system affecters, vomiting agents, choking agents, hallucinogens, sedatives, narcotics, depressants, and the like, and combinations of two or more thereof. In one embodiment, an incapacitating agent may include 3-quinuclidinyl benzilate (QNB, BZ), which may be an anticholinergic agent that may react with a sensor layer comprising, for example, choline. Alternative nervous system affecters may include commercially available over the counter (OTC) or prescription pharmaceutical compositions. In one embodiment, an incapacitating agent may include curare, or a curare analog or derivative.

Suitable lacrymators may include one or more of o-chlorobenzylmalonitrile, chloromethyl chloroformate, stannic chloride, sym-dichloromethyl ether, benzyl bromide, xylyl bromide, methyl chlorosulphonate, ethyl iodoacetate, bromacetone, bromomethyl-ethyl ketone, acrolein (2-propanal), capsaicin and derivatives, or the like.

A suitable vesicant may include one or more of sulfur mustard, nitrogen mustard, or an arsenical, such as Lewisite, and combinations of two or more thereof. Suitable sulfur mustard may include one or more of 2-chloroethyl chloromethyl sulfide, bis(2-chloroethyl) sulfide or dichloroethyl disulfide, bis (2-chloroethylthio) methane, 1,2-bis (2-chloroethylthio) ethane, 1,3-bis(2-chloroethylthio)-n-propane, 1,4-bis (2-chloroethylthio)-n-butane, 1,5-bis(2-chloroethylthio)-n-pentane, bis (2-chloroethylthiomethyl) ether, bis (2-chloroethyl thioethyl) ether, combinations of two or more thereof. Suitable nitrogen mustard may include one or more of bis (2-chloroethyl) ethylamine, bis (2-chloroethyl) methylamine, or tris (2-chloroethyl) amine, or combinations of two or more thereof. Suitable Lewisites may include one or more of 2-chlorovinyldichloroarsine, bis(2-chlorovinyl) chloroarsine, tris (2-chlorovinyl) arsine, or combinations of two or more thereof.

Suitable nerve agents may include cholinesterase inhibitors. In one embodiment, a cholinesterase inhibitor may include one or more of o-alkyl (Me, Et, n-Pr or i-Pr)-phosphonofluoridates, such as o-isopropyl methylphosphonofluoridate (sarin) or o-pinacolyl methylphosphonofluoridate (soman); o-alkyl N,N-dialkyl (Me, Et, n-Pr or i-Pr) phosphoramidocyanidates, such as o-ethyl N,N-dimethyl phosphoramidocyanidate (tabun); or o-alkyl S-2-dialkyl (Me, Et, n-Pr or i-Pr)-aminoethyl alkyl (Me, Et, n-Pr or i-Pr) phosphonothiolates and corresponding alkylated or protonated salts, such as o-ethyl S-2-diisopropylaminoethyl methyl phosphonothiolate (VX); and combinations of two or more thereof.

Suitable pulmonary agents may include one or both of phosgene (carbonyl chloride) and perfluroroisobutylene. Suitable toxins may include one or more of palytoxin, ricin, saxitoxin, or botulinum toxin, or combinations of two or more thereof.

Suitable blood agents may include forms of cyanide, such as salts, analogs and derivatives. A suitable solid salt of cyanide may include sodium, potassium, and/or calcium. A suitable volatile liquid form of cyanide may include hydrogen cyanide and/or cyanogen chloride.

In one embodiment, the sensor layer is operable to react and/or interact with spoilage indicators associated with fish products. For example, the sensor layer may be reactive with, or interactive with, one or more amine. Suitable amines may include one or more of histamine, trimethylamine, dimethylamine, ammonia, and the like.

In one embodiment, the sensor layer is operable to react and/or interact with spoilage indicators associated meat product. Suitable meats include beef, lamb, pork, chicken, and the like. For example, the sensor layer may be reactive with, or interactive with, one or more biogenic diamines, cadaverine or histamine, formed by the biological activity of bacteria. The spoilage factor, and diamine content, may be directly linked to the bacterial content of spoiled meat. In one embodiment, sensor may be reactive with, or interactive with, the decarboxylation of free amino acids on and in the meat by enzymes released by spoilage microorganisms. Two of these products, putrescence and cadaverine, may have a distinctive odor and may the odor concentration may correlate with surface bacteria counts. The surface bacteria count may be used to evaluate meat freshness.

A controller may communicate with one or more of the detectors, for example, via wire, Blue Tooth, or RFID device. In one embodiment, the system captures multiple target species and the controller analyzes one or more detector-generated signals to generate a data set. The generated data set may be compared to a common or determined data set. For example, the determined data set may include the target species associated with normal human exhalation. See Table 1.

TABLE 1
Normal human breath target species.

| | |
|---|---|
| 1. | Acetone |
| 2. | Isoprene |
| 3. | Acetonitrile |
| 4. | pTolualdehyde |
| 5. | Toluene |
| 6. | P,SDimethylhexane |
| 7. | Ethyl Alcohol |
| 8. | Acetaldehyde |
| 9. | Dichloronitromethane |
| 10. | 2,2,4-Trimethyl-I-pentanol |
| 11. | n-Propyl acetate |
| 12. | 2,2-Dimethyl-I-pentanol |
| 13. | Cyclohexane |
| 14. | Hexane |
| 15. | Thiolacetic acid |
| 16. | I-Heptanol |
| 17. | Cyclohexyl alcohol |
| 18. | Benzene |
| 19. | 2-Ethyl-I-hexanone |
| 20. | 2,3,5 Trimethylhexane |
| 21. | Ethyl Imercaptopropionate |
| 22. | Cycloheptatriene |
| 23. | p-Xylene |
| 24. | n-Butyl alcohol |
| 25. | 3,4 Dimethylhexane |
| 26. | Limonene |
| 27. | Isooctyl alcohol |
| 28. | Methyl-n-propyl sulfide. |
| 29. | 2-Ethyl-4-methyl-1-pentanol |
| 30. | Neopentyl acetate |
| 31. | Trans4nonenal |
| 32. | n-Heptane |
| 33. | Ethylbenzene |
| 34. | 5-Methyl4heptanone |
| 35. | Dimethylsulfide |
| 36. | P-Methyl-I-pentanol |
| 37. | pl)ichlorobenzene |
| 38. | Trans-3-hexen-I-ol |
| 39. | Capryl alcohol |
| 40. | Mesitylene |
| 41. | n-Hexylmercaptan |
| 42. | 3,4-Dimethylheptane |
| 43. | 2,3,3,4-Tetramethylpentane |
| 44. | 1Chlorohexane |
| 45. | Dichloroacetylene |
| 46. | 2,P-Dimethyl-I-octanol |
| 47. | 2,2,3,3-Tetramethylhexane |
| 48. | o-Xylene |
| 49. | 2,3,3-Trimethylhexane |
| 50. | Isopropylalcohol |
| 51. | 2,2-Dimethyl-I-hexanol |
| 52. | 5-Ethyl-I-butanol |
| 53. | Z,P-Dimethylheptane |
| 54. | Furan |
| 55. | Naphthalene |
| 56. | Thiocyclopentane |
| 57. | Cyclopentylalcohol |
| 58. | n-I\Ionane |
| 59. | Ethyl phenyl acetate |
| 60. | n-Amyl alcohol |
| 61. | Z,CDimethylheptane |
| 62. | 5-Nitropropane |
| 63. | 2,6-Di-tert-butyl-4-methyl-phenol |
| 64. | Methyl-tert-butyl-ketone |
| 65. | Di-Tert-butyldisulfide |
| 66. | 2,2-Dimethyl-Shexanone |
| 67. | 1,2-Diethylbenzene |
| 68. | 2,5-Dimethylheptane |
| 69. | 2-Methyl-3-heptanone |
| 70. | Isobutyl alcohol |
| 71. | m-Xylene |
| 72. | 2,2,5,5Tetramethylhexane |
| 73. | n-Decanal |
| 74. | SMethyl-2-butanol |
| 75. | Propiophenone |
| 76. | Ethylacetate |
| 77. | n-Decane |
| 78. | Isopropylbenzene |
| 79. | IEthylpentane |
| 80. | Di-n-Butylamine |
| 81. | N-Dodecane |
| 82. | o-Dichlorobenzene |
| 83. | Allylacetate |
| 84. | S,SDiethylpentane |
| 85. | n-Butyl acetoacetate |
| 86. | Benzylamine |
| 87. | Indene |
| 88. | Methylnaphthalene |
| 89. | ′L-Methyl-Spentanone |
| 90. | Coumarin |
| 91. | Phenylacetic acid |
| 92. | Ethyl valerate |
| 93. | 5-Methyl-3-heptanone |
| 94. | n-Octane |
| 95. | Cumic alcohol |
| 96. | Methanol |
| 97. | 2,4-Dimethyl-Shexanone |
| 98. | Octylacetate |
| 99. | Cycloheptadiene |
| 100. | 2-Methyl-1-octene |
| 101. | Ethyl Lmethylvalerate |
| 102. | o-Nitrotoluene |

By comparing the actual sensed target species to the expected data values, discrepancies and/or nuances can be identified. By analyzing, or comparing the discrepancies to a second data set, it may be possible to identify disease and/or ingested materials.

Ingestion of certain materials may be associated with metabolites of those materials. Target species that may include those metabolites may inductively indicate ingestion of the associated materials. Excretions and exhalations may be contacted to the sensor layer for the presence and quantity determination. In one embodiment, the device is inserted into a body to contact a bodily fluid. Some of such associations are listed in Table 2.

TABLE 2
Sources and associated metabolites as the target species.

| Target Species | Source |
|---|---|
| Acetaldehyde | L-threonine, ethanol |
| Acetone | acetoacetate |
| Ammonia | deamination of amino acids |
| Carbon monoxide | Heme, tobacco smoking, or pollution |
| Chloroform | halogenated organic compounds |
| Dichlorobenzene | halogenated organic compounds |
| 1,2-Dichloroethane | halogenated organic compounds |
| Dimethylamine | choline (intestinal bacteria) |
| Dimethyldifluorosilane | silicones |
| Dimethyl sulfide | methionine |
| Ethanethiol | methionine |
| (Volatile) fatty acids | carbohydrates, amino acids |
| | (diet and intestinal flora) |
| Isoprene | fatty acids (psychological stress increases |
| | isoprene in adults |
| Methanethiol | methionine, bacterial action in intestine |
| Methylethylketone | fatty acids |
| Methylisobutylketone | fatty acids |
| (Metabolic) nitrogen | bacterial action |

The controller (not shown) may communicate with one or more of the detectors. Multivariate calibration methods or univariate calibration methods may be used to analyze signals collected from the detector by the controller. A suitable controller may include a computer or a signal processor. Signal averaging may be achieved due to more than one measurement channel being employed in the analysis. Also, the concentrations of multiple species may be measured if present in the calibration samples. A calibration model may be built by using responses from calibration standard solutions. Multivariate calibration approaches may permit selective quantitation of several analytes of interest in mixed samples using if overlapping responses from different target species preclude the use of univariate analysis.

Multivariate calibration and analysis methods (based on more than one response) may provide relatively improved selectivity over univariate (one response) calibration and analysis methods. An exemplary method may provide an array of photodetectors responsive to different spectral ranges of optical response or signal that has been changed or affected by the reaction or interaction of the target species with the sensor layer. The detector may include photodiode elements that optically respond to different spectra ranges of optical response. An example of such multiwavelength-response photodiode array is an array available from Texas Advanced Optoelectronic Solutions, Inc. (Plano, Tex.).

The response from acoustic wave sensor component can also be univariate or multivariate. Multivariate analysis may be used for the acoustic wave sensor component. An example of the univariate response may include measurement of a resonant frequency. The example of the multivariate response may include measurement of the several parameters of the resonant crystal substrate, such as real and imaginary parts of the complex impedance. One can measure multiple parameters of the real and imaginary parts of the complex impedance, such as peak amplitude, width, and others.

Multivariate analysis methods include principal components analysis (PCA) that can be used to extract the desired descriptors from the dynamic data. PCA is a multivariate data analysis tool that projects the data set onto a subspace of lower dimensionality with removed co-linearity. PCA achieves this objective by explaining the variance of the data matrix X in terms of the weighted sums of the original variables with little or not loss of information. These weighted sums of the original variables are called principal components (PCs). Upon applying the PCA, the data matrix X is expressed as a linear combination of orthogonal vectors along the directions of the principal components:
X=t₁p^{T}₁+t₂p^{T}₂+ . . . +t_{A}p^{T}_{K}+E (Equation 1)
where tᵢ and pᵢ are, respectively, the score and loading vectors, K is the number of principal components, E is a residual matrix that represents random error, and T is the transpose of the matrix.

Multivariate data analysis provides a capability for warning of the occurrence of abnormalities in the measured data. To ensure the quality of the data several statistical tools may be applied. These tools are multivariate control charts and multivariate contributions plots. Other multivariate analysis methods may be selected based on end-use applications. Suitable other methods may include, for example, pattern recognition techniques such as hierarchical cluster analysis (HCA), soft independent modeling of class analogies (SIMCA), neural networks, and the like.

In one embodiment, the combination of the optical and acoustic wave detectors may expand the dynamic range of measured concentrations of analyte species. Specifically, a high concentration of target species may be detected by the first detector, and a low concentration of target species may be detected by the second detector.

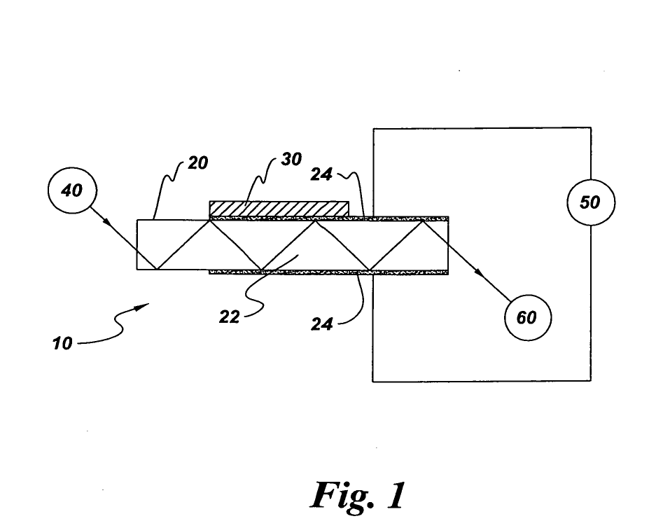

An apparatus 10 comprising an embodiment of the invention is shown in FIG. 1. The apparatus 10 includes (1) an opto-acoustic wave-sensing element 20 that includes an substrate 22, two electrodes 24, and a sensor layer 30. The sensor layer may be secured to at least one portion of the substrate. An electromagnetic (“EM”) radiation source 40 may be optically coupled to the opto-acoustic wave-sensing element 20. The electromagnetic radiation source may provide electromagnetic radiation having a wavelength that is matched to an optical property of the reaction product or the interaction product. A first detector 50 may detect a change in a mass of the acoustic wave-sensing element 20. A second detector 60 may detect an optical property of the interaction product or the reaction product.

The portion of the substrate that is the acoustic wave-sensing element 22 is a thickness-shear-mode (“TSM”) device. FIG. 1 depicts a QCM wherein the sensor layer is deposited on an electrode for maximum sensitivity. Alternatively, when the substrate is of the SAW, FPW, or SH-APM type, two sets of electrodes may be provided on the same surface of the sensing element. The sensor layer may be disposed or formed in a region defined by these two sets of electrodes.

A relation between the changes in the fundamental resonant frequency and the mass of the acoustic wave-sensing element is given in Equation 2.
Δf/f₀=−SₘΔm (Equation 2)

where Δf and Δm are the changes in the fundamental resonant frequency and the mass of the acoustic wave-sensing element, respectively; f₀ is the fundamental resonant frequency, and Sₘ is a proportionality constant with units of square centimeters per gram. Sₘ depends on the nature of the acoustic wave substrate, device dimension, frequency of operation, and the acoustic mode that is utilized. Values for the types of acoustic wave devices, or second detectors, mentioned above are shown in Table 3.

TABLE 3
Detectors and exemplary value ranges

| DETECTOR | f₀ (MHz) | Sₘ (cm²g⁻¹) |
|---|---|---|
| QCM | 6 | 14 |
| SAW | 112 | 151 |
| FPW | 2.6 | 951 |
| SH-APM | 104 | 65 |

Selective absorption between the target species and the sensor layer component may cause a mass change (Δm) in the sensor layer 30. The mass change may be detected. A chemical interaction may cause an equilibrium effect that, while temporary, may cause a detectable average mass change. Owing to the selectivity of the absorption, the interaction, or both, only those chemical species in the class of compounds that defines the target species group may effect the mass change. The selection of the sensor layer material, and the sensor layer component that selectively interacts with a target species, may identify the target species. Sensor layer components selectively interact with selected target species to yield products that absorb or emit electromagnetic radiation at characteristic wavelengths in the range of from UV to IR (or from about 100 nanometers to about 1 millimeter).

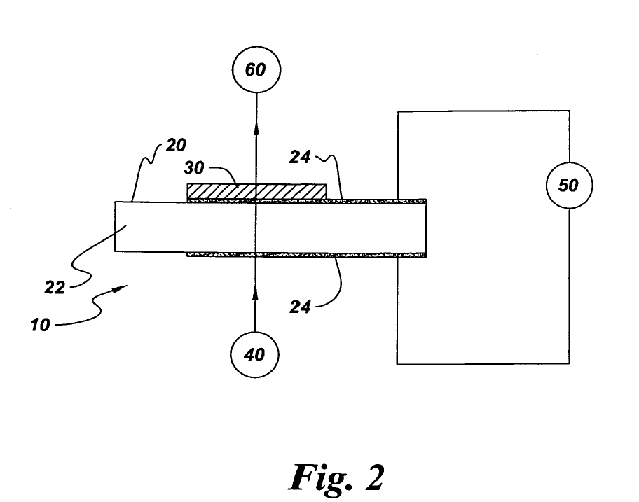

The substrate 20 is an acoustic wave material or element and an optically transparent or semitransparent waveguide. A focused input electromagnetic radiation having a characteristic wavelength of the interaction product may be launched into the opto-substrate 20, as shown in FIG. 1. A continuous or pulsed electromagnetic radiation at the characteristic wavelength traverses the first electrode, the substrate, the second electrode, and the sensor layer as shown in FIG. 2. A portion of the intensity or other measurable light property of the electromagnetic radiation may be modified by the interaction product and may provide information on the identity and amount of the target species. In the first and second embodiments, the substrate also functions as a waveguide and its material may be selected for minimum intrinsic optical loss.

In one embodiment, the substrate and the waveguide, each having a sensor layer deposited thereon, are separate but may be located in proximity to each other for the detection of a target species at that location. The materials of the substrate and the waveguide are thus selectable for their respective optimal performance. For example, the material for substrate may be chosen for its maximum response to a change in mass, viscoelastic or dielectric property of the sensor layer while that for the waveguide for its minimum optical loss. Similarly, the sensor layer material may be chosen to have optimal performance for its function. For example, the material of the sensor layer on the substrate may be chosen to have a maximum absorption capacity for the target species while that of the sensor layer on the waveguide for its compatibility with or its capacity to hold large amounts of the sensor layer component. In this embodiment, the sensor layer on the respective sensing element (i.e., the acoustic wave or the optical element) may be deposited at location that produces maximum sensitivity. For example, when the substrate may be a QCM, the sensor layer may be preferably deposited on an electrode at the center of the quartz crystal element while the sensor layer on the waveguide may cover a significant portion of the surface of the waveguide. In addition, in this embodiment the acoustic wave and the optical elements may have different geometries. For example, the substrate may be a thin circular wafer (as in the QCM) or a rectangular piece (as in the SAW sensor) while the waveguide may be a cylindrical optical fiber.

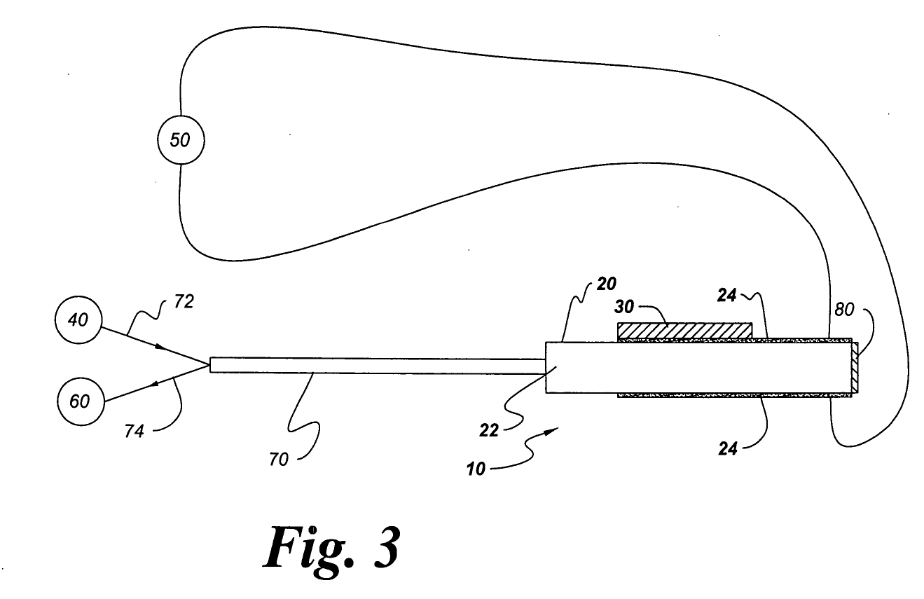

A waveguide 70 may be optically coupled to the opto-acoustic wave-sensing element, as shown in FIG. 3. The waveguide 70 may be an optical fiber in a bundle of optical fibers. A forward-traveling electromagnetic radiation 72 at the characteristic wavelength may be launched into this waveguide, traveling to the opto-acoustic wave-sensing element 20, which may be located remotely from the light source 40 and the detectors 50 and 60. A portion of the intensity of electromagnetic radiation 72 may be absorbed by the product of the chemical interaction in the sensor layer 30. The returning electromagnetic radiation 74 may be detected and its intensity may be measured by the detector 60. The absorption of light at the characteristic wavelength may provide an identification of the target species. The amount of light absorption further may provide an independent quantization of the target species beside that caused the change in the resonant frequency of the opto-acoustic wave-sensing element 20. A reflector 80 may be disposed on the opto-substrate 20 opposite to waveguide 70 to ensure that light may be reflected back to the waveguide 70 for detection by the detector 60. In addition, a lens (not shown) may be interposed between opto-substrate 20 and waveguide 70 to focus the returning light into the waveguide 70.

According to one aspect, an opto-acoustic wave chemical sensor may be used to one or more of detect, locate, or to quantify the amount of the target species at various depths in the soil. A small well may be drilled into the ground to a desired depth where the target species may be present. An opto-acoustic wave chemical sensor having a sensor layer containing a sensor layer component that can interact with the target species suspected to be present may be dropped into the well. The sensor layer component may react, or interact, with the target species to yield the optically sensitive and detectable product. A pulsed or continuous beam of light at the characteristic absorption wavelength of the product of chemical interaction may be launched into a waveguide leading to the opto-acoustic wave-sensing element to detect the absorbance of the product. If present, the target species may interact or react with the sensor layer component. As noted above, the sensor layer mass may increase, and the opto-acoustic wave-sensing element mass may correspondingly increase. The mass increase may change the resonance frequency. A change in the resonance frequency may allow for determination of the amount of the target species in the well.

The returning electromagnetic radiation having a modified optical property at the characteristic probe wavelength, traveling through the same or a different waveguide, may be detected above the well. The modulation of optical signal of the characteristic wavelength may provide a confirmation of the presence of and a positive identification of the target species in the well. The magnitude of the modulation of the optical signal further may provide an independent quantitation of the amount of target species. More than one opto-acoustic wave-sensing element or sensor, each having a different sensor layer and sensor layer component, may be dropped into the same well for the detection of different target species that are likely to be in the well. In such a case, it may be desirable to launch a beam of light at a different characteristic wavelength set for each specific possible product of chemical interaction into a separate waveguide associated with each opto-acoustic wave-sensing element.

Other uses of the sensor of the invention are also envisioned. For example, laying the opto-acoustic wave-sensing element on the area and determining the magnitude of the changes in the resonant frequency and the absorbance at the characteristic wavelength may determine the presence and quantity of a target species in an area. For example, several sensors of the invention may be bundled together, each of which may be used to detected and quantify a target species in an array of cells used for chemical synthesis in a combinatorial chemistry experiment.

Suitable examples of monitoring may include infiltration of surface water and of ground water by pollutants, as well as releases in air, radiation contamination, and pollution in waste effluents and storm/drain lines. Pollutants may include toxins, chemical weapons, heavy metals, halogenated materials, sewage, and the like. Monitoring may be for minerals and metals and general water quality in, for example, potable water. Other suitable applications may be in safety systems. Such safety systems may include hazardous material spill management, watershed protection, ecosystem management and restoration, fire detection, prevention, and response.

A self-contained monitoring unit may be configured to include a device according to an embodiment of the invention. The monitoring unit may be portable, and may include, for example, a microprocessor embedded controller assembly and a portable power supply. The power supply may include a battery, photovoltaic cell, fuel cell, microgenerator, or the like. The power supply may include a DC power supply and/or an AC power supply. The controller assembly may operate in an intermittently active mode, and in a power-down (“sleep”) mode between successive active mode events.

The monitoring unit may include an alarm producing the output indicative of the change in the monitorable characteristic of the sensor layer. Such alarm may include an audible alarm, a visual alarm, and/or a tactile alarm. The audible alarm may include a beeper, buzzer, siren, or any other sound source indicative of the alarm condition, such as the presence of the fluid being monitored in the environment associated therewith. The visual alarm may include a flasher, light, strobe, electroluminescent element, phosphor, scintillation coating, or any other element(s) producing a visually discernible output indicative of the alarm condition. The tactile alarm may include a buzzer, oscillator, vibrator, or other touch- or kinesthetically-perceptible output indicative of the alarm condition.

In one embodiment, a biodetection system may include a piezoelectric substrate; a sensor layer disposed on the substrate and operable to interact with, or react with, a target species; a first and a second electrode, that are spaced from each other and in communication with the substrate; and a first detector operable to detect the interaction or the reaction of the sensor layer with the target species based on a change in an optical characteristic of electromagnetic radiation propagated through the substrate, and a second detector operable to acoustically detect the interaction or the reaction of the sensor layer with the target species. The sensor layer may include one or more sensor layer components. The sensor layer components include one or more of an aptamer, antibody, protein, peptide, small molecule, nucleic acid sequence, flour-quencher pair dye, pH activatable dye, ion-sensor dye, chelator conjugated antibody dye with cleavable or non-cleavable linker, lanthanide chelate dye, cleavable linker disulfide dye, alkoxysilane dye, photochemically responsive dye, alkylsulfone dye, chromophore attachment moiety, chromophore-targeting moiety, chromophore probe, albumin, transferrin, fatty acid binding protein, globulin, a red blood cell component, lyphocyte, stem cell, lipoprotein, polylysine, polysaccharide, and thiol or disulfide group. A suitable chromophore probe comprises one or more of Cy5.5, Cy5, Cy7, IRD41, IRD700, NIR-1, 1C5-Osu, Alexflour 660, Alexflour 680, LaJolla Blue, FAR-Blue, FAR-Green One, FAR-Green Two, ADS 790-NS, ADS 821-NS, indocyanine green or analog thereof, indotricarbocyanine, or chelated lanthanide composition.

In one embodiment, a method may include associating the system with, or disposing within, a multi-step manufacturing process so that intermediate samples, precursors, or both are contacted to the sensor layer prior to proceeding to a subsequent manufacturing process step. The manufacturing process may produce one or more of cosmetics, food products, or pharmaceuticals, and the target species comprises one or more of water, amine, diamine, or short chain alcohol. Another method may include contacting the system to a bodily fluid suspected of containing the target species, and selectively detecting the target species in the bodily fluid.

### EXAMPLES

The following examples only illustrate methods and embodiments in accordance with the invention, and as such do not impose limitations upon the claims. Unless specified otherwise, all ingredients and equipment is commercially available from such common suppliers as Alpha Aesar, Inc. (Ward Hill, Mass.), Spectrum Chemical Mfg. Corp. (Gardena, Calif.), Thomas Scientific, Inc. (Swedesboro, N.J.), and the like.

Detection of Halogenated Alkenes

Trichloroethylene (TCE) reacts with polyethylenimine to yield polyglycinamide in the presence sodium hydroxide according to Equation 3. Polyglycinamide is quantitatively determined by an absorbance of IR electromagnetic radiation at 6.03 micrometers (wave number of 1658 cm⁻¹).

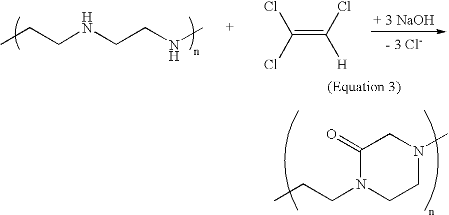

Similarly, N,N′-dialkylethylenediamine reacts with TCE to yield N,N′-dialkylglycinamide in the presence of a strong base, such as sodium hydroxide according to Equation 4.

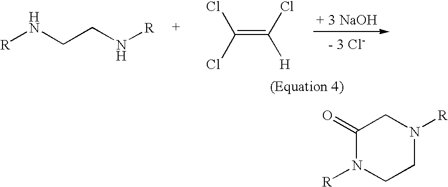

The reactions according to Equations 3 or 4 can provide the basis for detecting TCE by measuring the IR absorbance of the content of the capillary after the reaction at wavelength of 6.03 micrometers. FIG. 2 correlates the IR absorbance of a sample containing polyglycinamide at wavelength of 6.03 micrometers and the concentration of polyglycinamide in the same sample, which can be stoichiometrically related to the concentration of TCE that reacted.

Detection of Halogenated Hydrocarbons

Target species may include halogenated hydrocarbons. Halogenated hydrocarbons may include trichloroethane and trihalomethane. The halogenated hydrocarbons may react with pyridine or alkyl-substituted compounds of pyridine to yield colored products in the presence of a strong base according the Fujiwara reaction. A strong base can include sodium hydroxide, potassium hydroxide, or tetrabutylammonium hydroxide (“TBAH”). Colored reaction products of chloroform, bromodichloromethane, chlorodibromomethane, bromoform, and TCE strongly absorb at wavelengths of 538 nm to 540 nm. Thus, an embodiment can be used in conjunction with the Fujiwara reaction to determine heteroatoms and other halogenated hydrocarbons.

Determination of Polynitroaromatic Compounds

Polynitroaromatic compounds react with a diamine, such as ethylene diamine, to yield reaction products that exhibit strong absorbance in the visible light spectrum. The reaction can determine the spatial or quantitative distribution of these target species in an area or volume of air. Table 4 shows the wavelengths at the absorbance maxima of selected polynitroaromatic compounds. The wavelength signals identify the corresponding target species.

TABLE 4
Wavelengths of selected polynitroaromatic compound target species.

| TARGET SPECIES | Absorbance Maxima (nm) |
|---|---|
| 1,3,5-trinitrobenzene | 455, 540 |
| 2,4,6-trinitrobiphenyl | 455, 545 |
| 2,3′,4,5′,6-pentanitrobiphenyl | 450, 555 |
| 2,2′,4,4′,6,6′-hexanitrobiphenyl | 465, 530 |
| 2,4,6-trinitrotoluene | 465, 540 |
| 2,2′,4,4′,6,6′-hexatrinitrobiphenyl | 460, 550 |
| 2,2′,4,4′,6,6′-hexanitrostilbene | 460, 510 |
| 2,2′,4,4′-tetranitrobiphenyl | 355, 545 |
| 3,3′,5,5′-tetranitrobiphenyl | 450, 550 |
| 2,2′,6,6′-tetranitrobiphenyl | 350, 560 |
| 1,4,5,8-tetranitronaphthalene | 320, 620 |

The spatial and quantitative distribution of polynitrobenzene and selected substituted compounds may be determined. The sensor layer component for each target species obtains a reaction product having absorbance maxima shown in Table 5.

TABLE 5
Reaction product absorbance maxima

| | | Absorbance |
|---|---|---|
| | | Maximum or |
| TARGET SPECIES | SENSOR LAYER COMPONENT | Maxima (nm) |
| 1,3-dinitrobenzene | Methanolic KOH and acetone | 559 |
| 1,3,5- | dibenzylketone or 2,5-pentadione | 500 |
| trinitrobenzene | | |
| 2-ethoxy-1,3,5- | sodium hydroxide and methanol | 420, 478, 494 |
| trinitrobenzene | | |
| 2-methyl-1,3- | Strong base and acetone | 555 |
| dinitrobenzene | | |
| 2,4-dimethyl-1,3- | Strong base and acetone | 651 |
| dinitrobenzene | | |

Detection of Substituted Aromatic

The spatial and quantitative distribution may be determined of selected substituted benzene compounds using the piperonal chloride as the sensor layer component in the presence of a strong acid to obtain a reaction product having absorbance maxima shown in Table 6 according to the following reaction.

TABLE 6
Various moieties on target species and associated absorbance maxima.

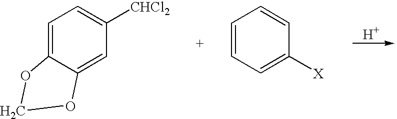

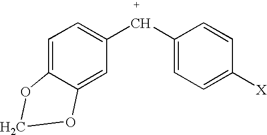

(Equation 5)

| TARGET SPECIES | Absorbance Maximum (nm) |
|---|---|
| CH₃ | 513 |
| OCH₃ | 527 |
| C₆H₅ | 560 |
| SCH₃ | 575 |
| SC₆H₅ | 585 |

Detection of Aromatic Aldehydes

A spatial and quantitative distribution may be determined of selected aromatic aldehydes using 2-nitrophenylhydrazine as the sensor layer component in a mixture of 98% (by volume) of dimethylformamide and 2% (by volume) of a 10% (by volume) aqueous solution of tetraethylammonium hydroxide to obtain a reaction product having absorbance maximum shown in Table 7.

TABLE 7
Various target species and associated absorbance maxima.

| | Absorbance |
|---|---|
| TARGET SPECIES | Maximum (nm) |
| Benzaldehyde | 575 |
| 1-napthaldehyde | 600 |
| 9-anthraldehyde | 630 |
| 4-dimethylaminocinnamaldehyde | 435 |
| 2-nitrobenzaldehyde | 650 |
| 4-nitrobenzaldehyde | 665 |

Although the exemplary target species disclosed above are organic compounds, appropriate sensor layer components may be used to identify and/or quantify inorganic compounds or inorganic/organic complexes.

Reference is made to substances, components, or ingredients in existence at the time just before first contacted, formed in situ, blended, or mixed with one or more other substances, components, or ingredients in accordance with the present disclosure. As used herein, interaction refers to a chemical interaction that forms a non-covalently bound species modifying the electronic nature of the interacting intermediates. That is, an interaction refers to two or more chemical compositions in equilibrium. A substance, component or ingredient identified as a reaction product, resulting mixture, or the like may gain an identity, property, or character through a chemical reaction or transformation during the course of contact. That is, a reaction product may form a distinct chemical identity separate from the initial reactants, and that new identity may be based on, for example, covalent bonding. In the range of permanency between an electronic interaction and a chemical reaction, there exists a plurality of states: ionic bonding, complexing, and ligand formation, for example. For purposes of this disclosure, it is necessary to classify these intermediate states as reaction products unless context or language indicates otherwise. Hence, interaction includes electronic interactions such as the equilibrium adsorption of gas phase molecules onto a surface, and reaction includes a relatively more longer-lasting chemical relationship.

The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

Reactants and components referred to by chemical name or formula in the specification or claims hereof, whether referred to in the singular or plural, may be identified as they exist prior to coming into contact with another substance referred to by chemical name or chemical type (e.g., another reactant, target species, or a solvent). Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product or final material.

The embodiments described herein are examples of compositions, structures, systems and methods having elements corresponding to the elements of the invention recited in the claims. This written description may enable those of ordinary skill in the art to make and use embodiments having alternative elements that likewise correspond to the elements of the invention recited in the claims. The scope of the invention thus includes compositions, structures, systems and methods that do not differ from the literal language of the claims, and further includes other structures, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed is:

1. A system, comprising a device that comprises:
a piezoelectric substrate;
a sensor layer disposed on the substrate and operable to interact with, or react with, a target species;
a first and a second electrode, that are spaced from each other and in communication with the substrate;
a first detector operable to detect the interaction or the reaction of the sensor layer with the target species based on a change in an optical characteristic of electromagnetic radiation propagated through the substrate; and
a second detector operable to acoustically detect the interaction or the reaction of the sensor layer with the target species.

2. The system as defined in claim 1, further comprising a portable power source operable to power the system and a housing that allows for portability of the system.

3. The system as defined in claim 1, wherein the sensor layer is configured to react or to interact with water vapor.

4. The system as defined in claim 1, wherein the sensor layer is configured to react or to interact with a relatively low molecular weight organic solvent.

5. The system as defined in claim 1, wherein the sensor layer is configured to react or to interact with gaseous products of a fire.

6. The system as defined in claim 1, wherein the system is configured to batch check pharmaceutical intermediates, precursor materials, or both pharmaceutical intermediates and precursor materials, and wherein the batch check comprises determining the presence, the concentration, or both the presence and concentration of one or more of water, alcohol, or solvent.

7. The system as defined in claim 1, wherein the system is configured to cooperate with a barrier filter, and the detector is operable to detect a breakthrough of the barrier filter.

8. The system as defined in claim 1, wherein the system is configured to monitor a mine environment and respond to contact by the sensor layer with one or more of gaseous fire products, gaseous exhaust products, hydrocarbon fuel, carbon dioxide, carbon monoxide, or methane.

9. The system as defined in claim 1, wherein the system is configured to monitor food products, and wherein the sensor layer is responsive to the presence, the concentration, or both the presence and concentration of one or more amine or amine derivative or analog.

10. The system as defined in claim 1, wherein the system is configured to monitor cosmetics, cosmetic intermediates, or cosmetic precursor materials and wherein the sensor layer is responsive to the presence, the concentration, or both the presence and concentration of one or more of water, alcohol, or solvent.

11. The system as defined in claim 1, wherein the system is configured to monitor the ambient atmosphere and wherein the sensor layer is responsive to the presence, the concentration, or both the presence and concentration of one or more chemical warfare agent or biological warfare agent.

12. The system as defined in claim I1, wherein the chemical warfare agent comprises one or more incapacitating agent; lachrymator; vesicant; nerve agent; pulmonary agent; toxin; malodorant; or derivative or analog of two or more of the foregoing.

13. The system as defined in claim 11, wherein the sensor layer comprises a selective bacteria or virus capture material corresponding to a biological warfare agent.

14. The system as defined in claim 1, wherein the system is configured to monitor a human breath or bodily fluid, and the sensor layer is responsive to the presence of ethanol in the breath or target species in the bodily fluid.

15. The system as defined in claim 1, further comprising a controller operable to receive one or more signals from one or more detector and to analyze the one or more detector signals.

16. The system as defined in claim 15, wherein the controller is further operable to perform multivariate analysis on two or more of the detector signals.

17. The system as defined in claim 15, wherein at least one detector and the controller are operable to communicate with each other through an RFID device.

18. The system as defined in claim 15, wherein the controller is operable to generate a data set based on the detector signals, and to compare generated data set to a determined data set to indicate one or more discrepancies between the generated data set and determined data set.

19. The system as defined in claim 18, wherein the target species comprises one or more compositions associated with exhaled breath, and the determined data set comprises the one or more compositions associated with exhaled breath, and wherein the discrepancies are indicative of ingested substances, disease conditions of a person responsible for the exhaled breath, or both.

20. The system as defined in claim 1, wherein the target species is indicative of food freshness or food spoilage.

21. The system as defined in claim 1, wherein the target species is indicative of the presence of a bio-fouling organism.

22. The system as defined in claim 1, wherein the sensor layer comprises sensor layer components, and the sensor layer components comprise one or more chromophore attachment moiety, a chromophore-targeting moiety, or a chromophore probe.

23. The system as defined in claim 1, wherein the sensor layer comprises sensor layer components, and the sensor layer components comprise one or more antibodies, aptamers, proteins, peptides, or small molecule.

24. A biodetection system, comprising:
a piezoelectric substrate;
a sensor layer disposed on the substrate and operable to interact with, or react with, a target species;
a first and a second electrode, that are spaced from each other and in communication with the substrate; and
a first detector operable to detect the interaction or the reaction of the sensor layer with the target species based on a change in an optical characteristic of electromagnetic radiation propagated through the substrate, and a second detector operable to acoustically detect the interaction or the reaction of the sensor layer with the target species;
wherein the sensor layer comprises one or more sensor layer components, and the sensor layer components include one or more selected from the group consisting of an aptamer, antibody, protein, peptide, small molecule, nucleic acid sequence, flour-quencher pair dye, pH activatable dye, ion-sensor dye, chelator conjugated antibody dye with cleavable or non-cleavable linker, lanthanide chelate dye, cleavable linker disulfide dye, alkoxysilane dye, photochemically responsive dye, alkylsulfone dye, chromophore attachment moiety, chromophore-targeting moiety, chromophore probe, albumin, transferrin, fatty acid binding protein, globulin, a red blood cell component, lyphocyte, stem cell, lipoprotein, polylysine, polysaccharide, and thiol or disulfide group.

25. The system as defined in claim 24, wherein the chromophore probe comprises one or more of Cy5.5, Cy5, Cy7, IRD41, IRD700, NIR-1, 1C5-Osu, Alexflour 660, Alexflour 680, LaJolla Blue, FAR-Blue, FAR-Green One, FAR-Green Two, ADS 790-NS, ADS 821-NS, indocyanine green or analog thereof, indotricarbocyanine, or chelated lanthanide composition.

26. A method, comprising:
disposing the system as defined in claim 1 with a multi-step manufacturing process so that intermediate samples, precursors, or both are contacted to the sensor layer prior to proceeding to a subsequent manufacturing process step.

27. The method as defined in claim 26, wherein the manufacturing process produces one or more of cosmetics, food products, or pharmaceuticals, and the target species comprises one or more of water, amine, diamine, or short chain alcohol.

28. A method, comprising:
contacting the system as defined in claim 1 to a bodily fluid suspected of containing the target species, and selectively detecting the target species in the bodily fluid.
